(19) United States
(12) Patent Application Publication
(10) Pub. No.: US 2016/0104157 A1
(43) Pub. Date: Apr. 14, 2016

(54) METHOD FOR PRODUCING A TRANSACTION SIGNAL

(71) Applicant: PAYCASH LABS AG, Kusnacht (CH)

(72) Inventor: Jürgen Wolff, Dusseldorf (DE)

(21) Appl. No.: 14/919,321

(22) Filed: Oct. 21, 2015

Related U.S. Application Data
(63) Continuation of application No. 13/699,916, filed on Nov. 26, 2012, now abandoned.

(30) Foreign Application Priority Data
May 25, 2010 (DE) 102010021374.8
Oct. 12, 2010 (DE) 102010048060.6

(51) Int. Cl. G06Q 20/40; G06Q 20/32

(52) U.S. Cl. CPC G06Q 20/401; G06Q 20/3274; G06Q 20/3276; G06Q 20/3278

(57) ABSTRACT

A method for generating a transaction signal using a first device and a second device includes generating first information dependent on a user-selected amount, transmitting the first information to a verification device and generating therefrom a signal, generating based on the first information with the verification device first verification information, transmitting the signal from the verification device to the first device where the signal is converted into a two-dimensional representation for display on the first device, recording the two-dimensional representation on the display of the first device with a camera of a second device and generating a recording signal, transmitting with the second device the recording signal, or other information dependent on the recording signal, to the verification device for generating second verification information, and generating the transaction signal when a comparison between the first verification information and the second verification information produces a predetermined result.

### CROSS REFERENCE TO RELATED APPLICATIONS

This application is a continuation application of and claims priority to co-pending U.S. patent application Ser. No. 13/699,916 filed Nov. 26, 2012, which is a U.S. National Stage Application under 35 U.S.C. 371 of International Application No. PCT/EP2011/002591, filed May 25, 2011, which claims the benefit of priority of German Patent Application Serial No. 10 2010 021 374.8 filed May 25, 2010, and German Patent Application Serial No. 10 2010 048 060.6, filed Oct. 12, 2010, all of which are incorporated by reference herein in their entireties.

### SUMMARY

The invention relates to a method for generating a transaction signal, in particular a transaction signal that is processed to cause an amount of money to be withdrawn from a first account and credited to a second account.

It is recognized from experience that there is a need for a first user to make an amount of money available to a second user. This can be accomplished through the exchange of banknotes and coins, which has the advantage that the first user can keep his identity secret to the second user, because the transferred bill or the transferred coin can allow the second to in turn execute transactions without having to know the identity of the first user. However, the use of notes and coins is increasingly perceived as an inconvenience, especially because this process requires the first user to keep on hand the correct banknote and/or the correct number of coins for the amount to be exchanged or the second user to have the correct change available.

It has been proposed to settle such transactions by using the mobile phones or portable computers provided by the majority of people participating in business activities, wherein a transaction signal is generated for deducting a sum of money from a first account and crediting the sum of money to a second account. EP 1 147 654 B1 discloses a process wherein the second user, to whom the amount of money is to be transferred, announces to the first user a phone number of a fee-based service-telecommunication connection. The first user calls this number from his mobile phone. The operator of the fee-based service telecommunication connection terminal is notified of the phone number of the first user and is at the same time authorized, for example, by a transfer of additional information between the mobile phone of the first user and the provider of the fee-based service telecommunication connection, to debit the first user for the amount agreed to between the first user and the second user. This system is disadvantageous, on one hand, because in practice the operator of the fee-based service telecommunication connection charges considerable fees to the second user or the first user for offering and performing this service. It is also not ensured that the first user actually pays the amount billed by the operator of the fee-based service telecommunication connection.

US 2010/0008535 A1 discloses a process wherein the second user records with the camera of his mobile phone an image of the credit card of the first user. From this image, information is generated that is transmitted to a verification device. Based on this information, the verification device debits the account of the first user. However, this approach also does not guarantee that the credit card presented by the first user is actually valid. It could also be forged. Furthermore, this system does not ensure that the amount charged to the user on his credit card bill will actually be paid.

It is known in the field of rail and air travel that a user orders from and pays a transportation service provider (second user) for a service, for example, a trip from a first location to a second location. The transport service provider provides to the first user a signal following the—separately transacted—purchase of the service which is transmitted by a device of the service provider to the mobile phone of the first user, wherein the signal is generated such that it can be converted by the mobile phone of the first user into the two-dimensional representation of a barcode which can be displayed on the display of the mobile phone. In order to verify that the first user is entitled to use the transportation service, the second user can request from the first user to convert the signal that the first user may have also stored on his mobile phone, with his mobile phone into the two-dimensional representation of a barcode and to display the same on the display of the mobile phone. The second user can record this two-dimensional representation on the display of the mobile phone of the first user with a camera of a verification device and produce a recording signal. The verification device may transmit the recording signal, or information that depends on the recording, to an additional verification device. The additional verification device can verify the recorded signal or the information that depends on the recording, and transmit confirmation information to the second user.

With the foregoing in mind, it is the object of the invention to provide an improved method for generating a transaction signal.

This object is solved by the subject matter of the independent claim 1. Advantageous embodiments are recited in the dependent claims and disclosed in the following description.

The invention is based on the fundamental idea that the users “exchange” instead of a banknote or a coin either by, on one hand, providing and, on the other hand, by photographing a two-dimensional representation or “exchange” instead of a banknote or a coin an NFC signal by sending a signal using the Near Field Communication (NFC) standard and receiving the NFC signal. This method allows, like the exchange of cash, the identities of the user to be kept secret from the respective other user. Furthermore, the users need not exchange information about credit cards and the like that may be misused by the recipient of the respective information. Finally, this method offers the possibility to check in advance whether the first user has at his disposal the amount he wants to transfer to the second user, and whether, for example, the account of the first user is blocked (e.g. in case of loss of the mobile phone or laptop). This can ensure that during a subsequent settlement of the amount agreed between the users there is no disadvantage for the user receiving the amount, when the first user, for example, does not have the amount he wants to exchange.

In a first variant of the inventive method for generating a transaction signal, the process is carried out using a first device and a second device, wherein the first device and/or the second device can be carried by a user. In the inventive method, at least the following steps are performed:
a user generates with a first device a first information which depends on an amount,
the first device transmits the first information to a verification device,
the verification device generates in response to the first information a signal which is adapted to be converted by the first device into an at least two-dimensional representation, which the first device can display on a display of the first device,
the verification device generates a first verification information based on the first information,
the signal is transmitted from the verification device to the first device,
the signal is converted by the first device into an at least two-dimensional representation, which is displayed by the first device on the display of the first device,
the at least two-dimensional representation on the display of the first device is recorded with a camera of a second device, producing a recording signal,
the second device transmits the recording signal, or a second information, which depends on the recording signal, to the verification device, or to an alternative verification device,
the verification device, or the alternative verification device generates from the recording signal, and/or from the second information, a second verification information, and
the first verification information and the second verification information are compared, and the transaction signal is generated when the comparison produces a predetermined result.

When comparing the inventive process for the exchange of banknotes and coins, the first user removes the amount he wants to pass the second user in the form of banknotes and coins from a container and presents them to the second user. This prior art approach is imitated with the method of the invention in that the user in a preferred embodiment of the inventive method, for example, enters an amount into his device, whereupon the device generates a first information which depends on the amount selected by the user and transmits this first information to a verification device. In response, the verification device generates a signal which depends on the first information and which is transmitted from the verification device to the first device, where it is converted into an at least two-dimensional representation on the display of the first device, which is reproduced by the first device on the display of the first device and which can therefore be presented to the second user. Similar to the receipt of the presented banknotes and coins, the second user receives the two-dimensional representation presented to him by recording with a camera of his (the second) device the at least two-dimensional representation on the display of the first device to produce a recording signal. When the second user forwards the recording signal, or a second information which depends on the recording signal, to a verification device, the verification device may generate, after verifying the recording signal or the second information, a transaction signal which causes an amount of money to be debited from an account of the first user and credited to an account of the second user. The process steps described in this paragraph relate to the representation of a preferred exemplary embodiment of the invention.

In a second variant of the inventive method for generating a transaction signal, instead of the steps of:
the verification device generates in response to the first information a signal which is adapted to be converted by the first device into an at least two-dimensional representation, which the first device can display on a display of the first device,
the verification device generates a first verification information based on the first information,
the signal is transmitted from the verification device to the first device,
the signal is converted by the first device into an at least two-dimensional representation, which is displayed by the first device on the display of the first device,
the at least two-dimensional representation on the display of the first device is recorded with a camera of a second device, producing a recording signal,
   the following steps are performed:
the verification device generates in response to the first information a signal which is transmitted from the verification device to the first device,
the verification device generates, based on the first information, a first verification information,
the first device generates, based on the signal, an NFC-signal which can be transmitted from the first device to a second device by using the Near-Field Communication standard, and which is transmitted from the first device to the second device using the Near-Field Communication standard, and
the second device generates, based on the received NFC signal, a recording signal.

This change of the steps to be performed reflects the fact that the inventive method is based on the concept that the users “exchange” instead of a banknote or a coin either a two-dimensional representation by, on one hand, providing and, on the other hand, photographing this representation, or “exchange” instead of a banknote or a coin an NFC signal by sending a signal using the Near Field Communication standard and receiving the NFC signal.

Near Field Communication, NFC, is a transmission standard for non-contact exchange of data over short distances. NFC enables the exchange of information. Security features are built into the hardware of the devices. Bluetooth is frequently used for access authentication and control.

The NFC technology is based on the combination of smart card and non-contact connection techniques. It operates in a frequency range of 13.56 MHz and provides a data transfer rate of, for example, 424 Kbit/s over a distance of, for example, 10 centimeters. This is desirable because making contact can then be considered as a consent to a transaction. NFC is standardized by ISO 14443, 18092, 21481 ECMA 340, 352, 356, 362 or ETSI TS 102 190.

The communication between NFC-enabled devices can be both active-passive and active-active (peer-to-peer), unlike the conventional contactless technology in this frequency range (only active-passive). Therefore, NFC is related to the technical field of RFID. NFC is mostly compatible with widely used smart card infrastructure based on ISO/IEC 14443-A (e.g., NXP's MIFARE technology) and ISO/IEC 14443-B (mainly in Francophile countries) as well as with Sony's FeliCa card (e.g. Octopus card in Hong Kong).

The inventive method is used to generate a transaction signal. The transaction signal may be, for example, the signal or one of the signals of an exchanged signal sequence which is exchanged, for example, between a first financial institution, with which the first user has an account, and a second financial institution, with which the second user has an account, in order to transfer in a conventional manner an amount of money from the account of the first user to the account of the second user. Such transaction signal is known from electronic banking. The transaction signal generated with the inventive process may also be a transaction signal which is used to debit a first amount from an account of a first user stored on a data processing device and credit the same amount to an account of a second user on the same data processing device. This second type of the transaction signal may be used, for example, when the first user and the second user maintain accounts with the same financial institution. This second type of transaction signal may also be used when a service provider offers to the first user and the second user the service of exchanging money and moreover requires the first user and the second user to both maintain accounts with the service provider. The service provider may, for example, require that the account of the first user with the service provider must have a positive balance before the service provider transfers an amount of money from the account of the first user maintained with the service provider to the account of the second user maintained with the service provider. The signal can also be exchanged between a service provider and a bank.

The inventive method can be used to transfer an amount from an account of the first user to an account of the second user (the generated transaction signal causes an amount to be transferred from the account of the first user to the account of the second user). The inventive method can also be used to transfer an amount from an account of the second user to an account of the first user (the generated transaction signal causes an amount to be transferred from the account of the second user to the account of the first user).

In an exemplary embodiment of the variant wherein the transaction signal generated according to a preferred embodiment causes an amount to be transferred from the account of the first user to the account of the second user, the first user inputs the amount he wants to send to the second user into the (his) first device; in the further course of the method, the first user transmits an NFC signal with the first device to a second device (the device of the second user) or displays an at least two-dimensional representation on the display of his first device which representation the second user records with the camera of the second device, thereby enabling a transaction signal to be generated in the further course of the method, with the effect that an amount is transferred from the account of the first user to the account of the second user. This exemplary case occurs, for example, in situations where the user himself freely selects the amount, or prefers to enter into his device an amount specified by the user.

In an exemplary embodiment of the variant wherein the transaction signal generated according to a preferred embodiment causes an amount to be transferred from the account of the second user to the account of the first user, the first user inputs the amount he wants to receive from the second user into the (his) first device; in the further course of the method, the first user transmits an NFC signal with the first device to a second device (the device of the second user) or displays an at least two-dimensional representation on the display of his first device which representation the second user records with the camera of the second device, thereby enabling a transaction signal to be generated in the further course of the method, with the effect that an amount is transferred from the account of the second user to the account of the first user. This exemplary case occurs, for example, in situations where the first user is a merchant who requests a specific amount from a customer and the customer accepts the request by receiving the NFC signal, or by recording the at least two-dimensional representation and possibly additional confirmation actions, and a transaction signal can be generated, which causes an amount to be transferred from the account of the second user to the account of the first user (merchant).

With the inventive method, a first device and a second device are used, wherein the first device and/or the second device are adapted to be carried by a user. A device which is adapted to be carried by a user refers in particular to a device whose dimensions (length×width×height) are less than 0.5 m×0.5 m×0.5 m and whose weight is less than 10 kg. Particularly preferred are the dimensions of less than 0.5 m×0.5 m×0.1 m. Particularly preferred are dimensions of less than 0.15 m×0.1 m×0.05 m. The weight of the first and/or second device is in a particularly preferred embodiment less than 5 kg, even more preferred less than 1 kg, and most preferred less than 0.5 kg. In a preferred embodiment, the first and/or the second device is a laptop or a mobile phone, preferably a tablet PC, a navigation device, a television set, a payment terminal, a game console, or an MP3 player.

In a preferred embodiment, the first device is a mobile phone or a laptop while the second device is a stationary device, which cannot be carried by a user. For example, the second device may be a ticket machine having a camera to which the user of the first device presents the at least two-dimensional representation displayed on the display of the first device, thereby allowing the user to pay the amount that must be paid for generating the ticket, or wherein the user of the first device holds his first device in the reception range of the second device for exchanging an NFC signal between the second device and the first device. The second device may, for example, also be the cash register of a business, such as a supermarket, wherein the user of the first device presents to the camera of the second device the at least two-dimensional representation displayed on the display of his first device for payment of the selected goods, or wherein the user of the first device holds his first device within the receiving range of the second device for exchanging an NFC signal between the second device and the first device. The second device may also be a computer, such as the computer of the user, onto which the user wants to load software, a music title, a movie or an electronic book from the Internet. To pay for this service, the first user may present to the camera of the computer the at least two-dimensional representation displayed on the display device of his first device, and thus pay for the service in response to a request from the computer.

In a particularly preferred embodiment, the second device is a mobile phone, whereas the first device is a stationary device that cannot be carried by the user. For example, the first device may be an automated teller machine (ATM), from which the user can withdraw an amount of money and credit the amount to another account, such as the account he can then use to perform transactions with his mobile phone. To this end, the ATM may display on its display the at least two-dimensional representation. The first user can record with his second device embodied as a mobile phone and with the camera of the mobile phone the two-dimensional representation presented by the ATM and produce the recording signal, or enable an exchange of a NFC signal between the second device and the first device by moving the second device within the reception range of the first device, thereby generating the transaction signal at the additional steps of the inventive method.

With the inventive method, a first information which depends on an amount is generated by a user with a first device. In a preferred embodiment, the user generates with the first device a first information which depends on an amount selected of the user. In a particularly preferred embodiment, the amount selected by the user is a numeric value, for example, a numeric value in the format of a sum of money. The user can generate the first information by entering the amount in response to an input request from the first device by way of an input device of the first device, such as a keyboard or a touch-sensitive display, with the first device generating the first information from this input. In a particularly preferred embodiment, the input device has number fields with which the user can enter any amount. The input request may, however, also correspond to a presentation of preselected amounts, for example, a staggered amount of banknotes and coins in a pre-selected currency, whereby the user can select the amount via the input device, such as a keyboard, or preferably a touch-sensitive display, by selecting a representation corresponding to the desired amount. In a preferred embodiment of the last-described embodiment, the user may, for example, also select an amount that is not represented by the displayed symbols by individual selecting symbols multiple times. The user may, for example, select the amount of EUR 30.00 by selecting once a representation of a EUR 20.00 note and once the representation of a EUR 10.00 note. In a preferred embodiment, the amount is selected by selecting images of amounts stored in the first device and displayed on the display of the first device. In this preferred embodiment, the amounts to be displayed are permanently stored in a memory of the first device. In this preferred embodiment, the amounts are preferably uploaded to the first device from an external device and in the temporal context of the execution of the inventive method not generated before the user generates the first information, especially preferably not within 5 minutes, more preferably not within 1 hour. In a preferred embodiment, the inventive method is not used to pay fixed amounts, which are, for example, uploaded to the first device from an external device, for example, over the Internet, for example, when the user wants to download software, a music title, a movie or a book on his first device and is required to pay a certain amount for this service. Preferably, the inventive method should be used to generate a transaction signal for an arbitrary amount freely selected by the user and not for an amount selected by the user, which has been externally predetermined, although the method of the invention can of course be used for such applications as well.

In a preferred embodiment, the inventive method is implemented so as to give the user the opportunity to enter an arbitrary amount, and to produce the first information based on this input. More preferably, the user selects the amount based on the first information without resorting to a still undefined fixed amount that is stored, for example, in the first device, wherein selecting the fixed amount is understood as selecting a fixed amount and not freely selecting a freely selectable amount by resorting to pressing the symbols displayed on a touch display.

However, the first information generated by the user with the first device need not depend on an amount that is selected by the user. In a preferred embodiment, the user generates with the first device a first information by receiving from an additional device, in particular from the second device, a request signal that depends on an amount, and generates based on this request signal the first information, which depends on an amount. Thus, the additional device, in particular preferably the second device, for example a cash register, may generate a request NFC signal that depends on an amount, for example, an amount to be paid for a product, which is transmitted by using the Near Field Communication standard from the additional device, in particular preferably the second device, to the first device using the Near Field Communication standard. The first user can generate a first information based on the request NFC signal data received by the first device. This can, for example, be accomplished in that the first user performs an authentication step with the first device. For example, when the first device receives the NFC signal, a prompt (optical, acoustic or haptic) may be generated by the first device, which the first user must confirm for generating the first information. For example, a prompt field may be displayed on a display that possibly already exists on the first display, wherein the first user confirms the prompt field with an input on a keyboard potentially provided on the first device or with an input on a potentially provided touch-sensitive display of the first device. This confirmation may also be implemented, for example, by entering a verification code (PIN). The prompt may, for example, also include a tone generated by the first device, in response to which the first user enters a confirmation with an input on a keyboard potentially provided on the first device or with an input on a potentially provided touch-sensitive display of the first device. Again, the input of a PIN may be required. The prompt may also include generating a haptic signal with the first device, for example a vibration over a time period, in response to which the first user enters a confirmation with an input on a keyboard potentially provided on the first device or with an input on a potentially provided touch-sensitive display of the first device. Again, the input of a PIN may once more be required.

When the embodiment is implemented, in which the first user receives with the first device a request signal that depends on an amount, and the first information, which depends on an amount, is generated based on this request signal, the first information may be generated with the first device without additional interaction by the user with the first device, and after receiving the request signal. This approach can be used, for example, in cases where it is determined that the first user agrees to generate the first information merely by allowing the first device to receive the request signal. However, it is particularly preferred that the first information after receiving the request signal is generated only after additional interaction by the first user with the first device, for example, after confirming a request. This can prevent that a first information is generated without the consent by the first user.

The first information generated by the user is preferably a signal or part of a signal, which can be exchanged between the first device and a verification device. The first information may be a signal or part of a signal which a mobile phone exchanges with a verification device, such as a data processing device embedded in the mobile network, to send an SMS or a MMS message. The first information may also be a signal or part of a signal, which the first device, which can be implemented in this embodiment as a mobile phone or a computer, exchanges with a verification device, such as a data processing device connected to the Internet, which the first device can access via a wireless network (for example, W-LAN or mobile network), but also via a wired network. The signal exchange between the first device and the verification device may also take place via a LAN connection or, for example, via a terrestrial telephone line. A mobile phone or terrestrial telephone line between the first device and the verification device may also be embodied as a dial-up connection. The information exchange between the first device and the verification device may take place by way of an encrypted signal.

In a particularly preferred embodiment, the first information is a signal or part of a signal that can be additionally processed in the verification device, wherein the first information is included in the signal, or in the part of the signal, such that process steps can be carried out in the verification device which depend on the value of the amount, commensurate with the value of the amount, because the verification device is able to read out the value of the amount through the signal, or through the part of the signal.

With the inventive method, the first device transmits the first information to a verification device. In a particularly preferred embodiment, the first device transmits a signal which represents the first information, or which has a part that depends on the first information. The verification device is preferably a data processing device, which is configured to receive signals from the first device. In a particularly preferred embodiment, the verification device is a data processing device, which is embedded in the Internet and can exchange signals with the first device via the Internet either wired, or wired and in part over a wireless network, or only over a wireless network. A verification device is also to be understood as a network of data processing systems, for example, the network of data processing systems of a bank.

In a preferred embodiment, the first information is transmitted to a verification device only when the user has entered a (possibly additional) confirmation in response to a (possibly additional) request. For example, the first user may be prompted, after the first device has generated the first information, by a prompt (optical, acoustic, tactile) to allow transmission of the first information to a verification device. In a preferred embodiment, a confirmation by entering a PIN may be required.

The content of the first information may include further partial information in addition to the amount. For example, information about an identification feature of the first device may be included as part of the first information. A possible identification feature may be, for example, the device ID/identification number. Part of the first information may also include information about a PIN entered by the first user in response to a request. In a preferred embodiment, the content of the first information or separately transmitted location information may include information about the location of the first device. In a preferred embodiment, the first device is therefore constructed in such a way that it can determine its position, for example by utilizing the Global Positioning System (GPS) and can transmit the information about its position as part of the first information, or as a separately transmitted location information from the first device to the verification device. The verification device may be configured to check the location of the first device based on the information provided to the verification device and, if necessary, block the additional implementation of the method, or block the account of the first user.

In the first alternative of the inventive method, which starts from the “exchange” of an at least two-dimensional representation, the verification device generates a signal depending on the first information, wherein the signal can be converted by the first device into an at least two-dimensional representation, which representation the first device can display on a display of the first device. In a particularly preferred embodiment, the signal generated by the verification device can be converted by the first device into an at least two-dimensional representation of a barcode. In particular, a barcode also includes a QR code. A barcode is also understood to include an Aztec Code, a brandable dot code, a QuickMark, a BeeTagg, a data matrix, a Cool-Data-Matrix, a Trillcode a Connexto and/or a TMS code.

In the second alternative of the inventive method, which starts from the “exchange” of a NFC-signal, the verification device generates based on the first information a signal that can be transmitted to the first device, wherein the first device can generate the NFC signal based on the signal.

The signal and/or the at least two-dimensional representation converted by the device and/or the NFC signal may contain information about the selected amount, for example as part of the signal, or for example as part of the converted two-dimensional representation, or as part of the NFC signal. However, the signal may also be implemented as a consecutive case number managed by the verification device, wherein for example a table may be stored in the verification device, which associates the selected amount with the case number. A method step for generating a signal based on the first information is therefore not necessarily understood as requiring that the signal must also contain information about the actual value of the selected amount. Generating the signal in response to the first information may also be understood such that reception of a first information by the verification device causes the verification device to generate a signal, even when this signal does not contain the actual value of the selected amount, as illustrated for example in the immediately preceding embodiment relating to the case numbers. For example, random numbers may also be used as basis for generating the signal instead of the case number.

The signal generated by the verification device may contain other information, such as a validity period. This information about the validity period may be used, for example, to generate on the display of the first device a reproduction indicating when (in absolute terms), or like a counter after a time frame has elapsed, the two-dimensional representation becomes invalid, or a transmitted NFC signal becomes invalid, or the NFC signal may no longer be transmitted. An invalid two-dimensional representation and/or an invalid NFC signal refer to a two-dimensional representation and/or an NFC-signal wherein no transaction signal is generated after carrying out the additional inventive method steps when comparing the first verification information and the second verification information. In a preferred embodiment, the validity period is less than 1 week, more preferred less than 1 day, particularly preferred less than 1 hour and even more preferred less than 5 minutes. Similarly, the first device may be configured so that it no longer transmits the signal based on the NFC signal after the expiration of the validity period.

In a preferred embodiment, the signal may be generated in the verification device based not only on the first information, but also in response to other information. For example, the verification device may check after receipt of the first information, whether an account of the first user has sufficient funds in excess of the selected amount or whether the account of the first user has, for example, overdraft protection and or a credit limit in excess of the selected amount. If in the preferred embodiment the signal is generated in addition not only based on the first information, but also based on additional information, then the verification device may in this preferred embodiment not produce any signal when the verification device receives no additional information, for example a release that the user's account has sufficient funds.

In a preferred embodiment, the signal transmitted from the verification device to the first device contains no information that would allow the identity of the user to be revealed. Preferably, the signal includes no information that contains—even in encrypted form—the name, a possibly selected alias name, the phone number, the bank or the bank account or a credit card of the user. In a preferred embodiment, the signal which is transmitted from the verification device to the first device and/or the at least two-dimensional representation and/or the NFC signal are used to inform the second device to which verification device the second device must transmit the recording signal, or a second information that depends on the recording signal, so that verification device can generate from the recording signal and/or from the second information a second verification information, which can then be compared with the first verification information, wherein the transaction signal may be generated when the comparison yields a predetermined result.

With the inventive method, the verification device generates a first verification information based on the first information (and in a preferred embodiment, also based on additional information). This verification information may include, for example, the amount associated with the at least two-dimensional representation or with the signal from which the NFC signal is generated. The verification information may additionally include information about the validity period of the at least two-dimensional representation. The verification information may also include the at least two-dimensional representation, or parts thereof, or may contain the signal or parts of the signal from which the NFC signal is generated. The verification information may also include information about a currency, the account-holding company of the first user and bonuses, for example, when the first user is entitled to a bonus and the transaction signal is to be used to debit from a bonus balance. The verification information is preferably produced in order to perform in a later step of the method a comparison with a second verification information, which is generated by evaluating a camera recording of the at least two-dimensional representation, or which is generated based on an NFC signal received from a second device. With the inventive method, the comparison of the verification information is a prerequisite for generating the transaction signal which is generated when the comparison produces a predetermined result. In a preferred embodiment, the first verification information therefore includes all necessary security contents for generating the transaction signal after the comparison with the second verification information. The verification information may additionally include information about the first user, or an identification feature of the first device. The verification information may also contain a logo of the account holding company.

The first verification information may be stored in the verification device. Likewise, the verification information or a copy of the verification device may be stored in a different device, for example in an alternative verification device. For example, the first verification device may be the computer network of a first bank. This verification device may generate a verification information and store the verification information in a neutral computer network. The alternative verification device which generates from the recording signal, and/or from the second information, a second verification information, may be for example the computer network of a second bank, which can also transmit the second verification information to the neutral computer network, which then compares the first verification information and the second verification information with one another and transmits the result of this comparison to both the first verification device (the computer network of the first bank) and the alternative verification device (the computer network of the second bank), so that a transaction signal can be generated between the first verification device and the alternative verification device.

The signal can be transmitted from the verification device to the first device using the same transmission means that were used to transmit the first information from the first device to the verification device.

The signal transmitted from the verification device to the first device can be used by the first device to directly generate the at least two-dimensional representation, and to display the at least two-dimensional representation on the display of the first device, and/or to directly generate the NFC signal. The signal transmitted from the verification device to the first device and/or an internal signal dependent therefrom may also be stored in a memory of the first device, so that in a preferred embodiment of the inventive method, the first device will reproduce the at least two-dimensional representation on the display of the first device, and/or generate the NFC signal only after receiving a request controlled by the user.

In the first alternative of the inventive method, which starts from the “exchange” of an at least two-dimensional representation, the at least two-dimensional representation on the display of the first device is recorded with a camera of a second device, generating a recording signal. A camera is to be understood as any device capable of generating a recording signal from a two- or three-dimensional optical representation. In particular, the term camera is to be understood to include digital cameras or digital video cameras and analog video cameras. A camera is also understood to include for example a scanner, which is known in industrial applications for reading a barcode or from supermarket checkouts or transportation service providers for reading tickets having a QR code.

In a preferred embodiment, the second device may generate an optical and/or acoustic signal when the at least two-dimensional representation on the display of the first device is held at a location which is at the focal point of the camera of the second device. The second device may also generate optical or acoustic signals which support movement of the at least two-dimensional representation on the display of the first device to a location in the focus of the camera of the second device. For example, red signals or low-level acoustic signals may be generated when the at least two-dimensional representation on the display of the first device is located outside the focus of the camera of the second device, while green signals or louder acoustic signals may be generated, when the at least two-dimensional representation on the display of the first device is located within the focus of the camera of the second device.

In the second alternative of the inventive method, which starts from the “exchange” of an NFC signal, the NFC signal is transmitted from the first device to the second device using the Near Field Communication standard.

In a preferred embodiment, the first and/or second device may generate an optical and/or acoustic signal, when the first device and the second device are brought into a spatial relationship to one another, allowing transmission of the NFC signal. The first and/or the second device may also generate optical or acoustic signals, which support a movement of the first and/or the second device to a location where the NFC signal can the transmitted. For example, red signals or low-level acoustic signals may be generated when the first and/or the second device are located outside a location where the transfer of the NFC signal is possible, while green signals or louder acoustic signals may be generated when the first and/or second device are at a location where the transfer of the NFC signal is possible.

With the inventive method, the second device transmits the recording signal, or a second information dependent on the recording signal, to the verification device or to an alternative verification device. The recording signal and the second information can be transferred immediately after generation of the recording signal. The recording signal and the second information may also be temporarily stored in a memory of the second device and transmitted at a later stage to the verification device, or to an alternative verification device. The recording signal and the second information may include information about the time of the recording.

In a preferred embodiment, the recording signal and/or the second information are transmitted only when the user has inputted a (possibly additional) confirmation in response to a (possibly additional) request. For example, the second user may be prompted, after the second device has generated the recording signal and/or the second information, by a prompt (optical, acoustic, tactile) to release the transmission of the recording signal and/or of the second information to the verification device, or to the alternative verification device. In a preferred embodiment, confirmation by entering a PIN may be required.

In a preferred embodiment, the content of the second information or of a second separately transmitted location information may contain information about the location of the second device. In a preferred embodiment, the second device is therefore configured so that it can determine its position, for example by utilizing the Global Positioning System (GPS) and transmit the information about its position as part of the first information, or as a separately transmitted location information from the second device to the verification device. The verification device may be configured to check the location of the second device based on information transmitted to the verification device and, if necessary, block the further execution of the method. In a preferred embodiment, the verification device receives from both the first device and the second device information about the location of the first device and the location of the second device. This enables the verification device to determine whether the first device and the second device are in such close proximity to one another, that it is plausible that a recording of the at least two-dimensional representation on the display of the first device was recorded with a camera of the second device, and/or a signal could be transmitted from the first device to the second device using the near field communication standard. It may be sufficient for verifying the close proximity, for example, that the first device and the second device are located within in the same cell of a mobile network.

The contents of the second information may also contain partial information in addition to the amount. For example, information about an identification feature of the second device may be part of the second information. A possible identification feature may be, for example, the device ID/identification number. Furthermore, information about a PIN entered by the second user in response to a request may be part of the second information.

With the inventive method, the verification device, or the alternative verification device, generates a second verification information from the recording signal and/or from the second information. The first verification information and the second verification information are compared, and the transaction signal is generated when the comparison produces a predetermined result.

The generated transaction signal may include information regarding the selected amount, for example when the transaction signal is employed to reduce the account of the first user by the selected amount and to credit the selected amount to the account of a second user. Similarly, the transaction signal may include information about the first and/or the second user, so that the information can be reproduced in the account of the first user and/or in the account of the second user, indicating which amount was transferred from the first user to which account of the second user. But it is also possible to perform the inventive method by keeping the identity of users secret. In this embodiment, the transaction signal may include, for example, information about the date and time of the recording made with the camera. This information may satisfy the first user and the second user, respectively, to verify that his account was debited correctly, or that his account was credited correctly.

In a preferred embodiment, the first verification information is canceled following a first, successful, first comparison with a second verification information verification information triggering a transaction signal, thus preventing generation additional transaction signals can be generated. This prevents the multiple utilization of the two-dimensional representation on the display of the first device.

In a preferred embodiment, the first information is transmitted from the first device to the verification device, the signal is transmitted from the verification device to the first device and/or the recording signal and/or the second information is transmitted from the second device to the verification device, or to the alternative verification device via a mobile phone network, for example, a cellular network or a computer wireless network, such as a W-LAN. In a preferred embodiment, the transmission takes place over only a partial section via the wireless network, and also includes transmission sections in which the transfer takes place via a cable.

In a preferred embodiment, the first device is configured to process a program routine, wherein the user enters for generating the information, when the program routine has started, only an amount selected by the user and no additional information. If a method step is provided in a preferred embodiment of the inventive method, in which the connection of the first device with the verification device is authenticated, for example when information that can distinguish the first device is exchanged between the first device and the verification device, then the authentication is carried out in the preferred embodiment based on the information stored in the first device and, in the preferred embodiment, not based on additional information which the user enters over time when generating the first information, and in particular only based on additional information that the user must enter at least more than 5 minutes, in particular more than 1 hour before the user generates with the first device a first information. In a preferred embodiment, when executing the method of the invention, it should be avoided that the user is required to select more than the amount for generating the first information. This is intended to simplify the method of the invention so that the user is particularly fond of performing the method, in particular because he does not require any additional information for its implementation, for example, there is no need to remember authentication codes and the like, or information that must be kept secret, for example information from his credit card.

In a preferred embodiment, the second device is configured to process a program routine, wherein the second device generates the recording signal to be transmitted, or the second information to be transmitted, when the program routine has started based on the recording signal generated by the camera, without requiring any additional information to be entered into the second device. This preferred embodiment is also intended to simplify handling of the inventive process and to not require a user who takes with the second device a picture of the at least two-dimensional representation to have additional information on hand for continuing the inventive process. For example, this may obviate the need for the user who takes a picture of the display with the camera of the second device to enter an authentication code.

It is evident that security risks exist with the two last-described preferred embodiments of the invention, when no additional information must be entered for generating and transmitting the first information and for generating and transmitting the recording signal and/or the second information. In this preferred embodiment of the invention, these security risks are however accepted, because the method of the invention should preferably be handled in the same way as the consumer handles cash. Here, too, there is the risk that a banknote held by a first consumer gets in the wrong hands. However, this risk is accepted by consumers because it allows particularly easy handling of amounts. In a preferred embodiment, this ease of handling amounts should also be possible with the inventive method. The inventive method can provide other security features. For example, the verification device may generate a signal only when the first information was generated in response to an amount that is lower than a predetermined amount. Likewise, the present process can be carried out with reloadable accounts which consumers specifically load for carrying out the method of the invention. If, in such an embodiment, the signal is generated by the verification device only when the account of the consumer has sufficient funds, then it can be ensured with this embodiment that the consumer loses at most the amount he deposited to this particular account.

In a preferred embodiment, a confirmation information is transmitted to the first device and/or the second device when the transaction signal is generated. This confirmation information may, for example, contain only the information that the transaction has been successfully completed. However, the confirmation information may also contain additional information. For example, the confirmation information transmitted to the first device may inform the user of the account balance of his account. Similarly, confirmation information transmitted to the second device may inform the user of the second device of the account balance of his account. The confirmation information may also be used to print out a receipt. Thus, in situations where a customer pays a merchant for goods according to the method of the invention, a confirmation information can be sent to the device of the merchant, allowing the merchant to print a receipt which he hands over to the customer. This provides the customer with an additional proof that he has paid the debt to the merchant.

### BRIEF DESCRIPTION OF THE DRAWINGS

The invention will be explained in more detail with reference to a drawing which merely illustrates exemplary embodiments. In the drawings:

FIG. 1 shows a first flow chart of the method according to the invention,

FIG. 2 shows a second flow chart of the method according to the invention,

FIG. 3 shows a third flow chart of the method according to the invention,

FIG. 4 shows a fourth flowchart of the method according to the invention,

FIG. 5 shows a fifth flowchart of the method according to the invention.

### DETAILED DESCRIPTION

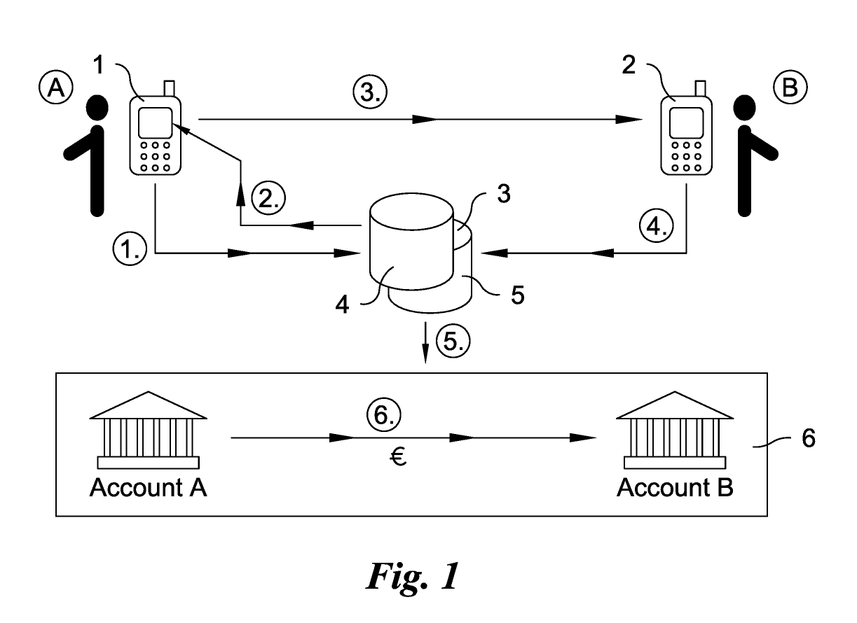

FIG. 1 illustrates a first user A and a second user B. The first user A has a first device 1 in form of a mobile phone. The user B has a second device 2 in form of a mobile phone. The first device 1 and the second device 2 communicate with a verification device 3 via a mobile phone network, wherein the verification device 3 includes a first data processing device 4 and a second data processing device 5.

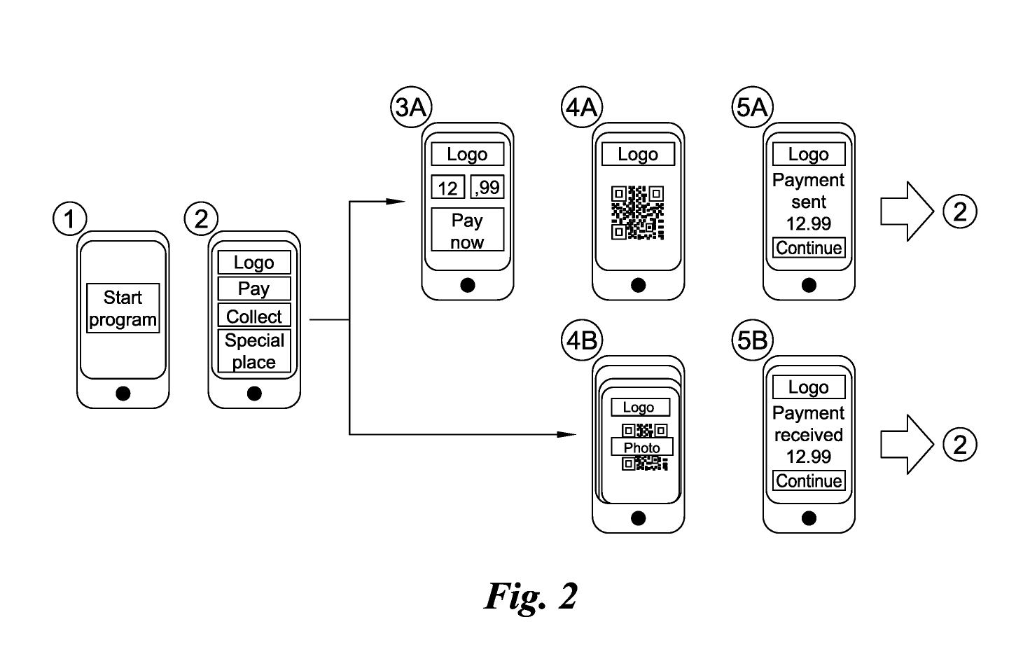

As shown in FIG. 2, the user A can perform the method steps of the method according to the invention by starting a program routine (“Start Program”) on his mobile phone. This program routine is stored in a memory of the mobile phone. The mobile phone (first device 1) is logged into the mobile phone network and in contact with the first verification device 3 via the mobile phone network or an alternative wireless network no later than at the time when the first user transmits the first information to the verification device 3 (step 1 in FIG. 1, step from the diagram 3a to the diagram 4a in FIG. 2). After the program routine has started, the program routine can query the user whether he wants to make a payment later in the program routine (render the barcode on his display for photographing by a second device) or whether he wants to receive a payment later in the program routine, i.e. photograph the barcode displayed on a display of another device. At this time of the program routine the account balance may be communicated to the user (step 2 in FIG. 2).

The first user selects at step 2 of FIG. 2 the option to pay an amount (“Pay”). Thereupon, the first user is prompted by the program routine to select an amount (step 3 in the FIG. 2). User A enters on an (unillustrated) input device, for example a presentation routine on the touch-sensitive display of the first device, the amount selected by the user A (here: 12.99). The user confirms his selected amount by selecting a confirmation button (“Pay Now”). After this input, the first device 1 produces an information that depends on the amount selected by the user. The first device transmits the first information to the verification device 3 (step 1 in the FIG. 1). Based on the first information, the verification device 3 generates a signal, which is adapted to be converted by the first device 1 into a barcode representation, which the first device 1 can display on its display. The verification device 3 also generates a first verification information based on the first information. The signal is transmitted from the verification device 3 to the first device 1 (step 2 in FIG. 1) and converted by the first device 1 into a two-dimensional representation of a barcode, which the first device 1 reproduces on the display of the first device (step 4a in the FIG. 2).

A second user has carried out the steps 1 and 2 of FIG. 2 on his second device 2, and has selected at step 2 of FIG. 2 that a payment is to be received (“Collect”) in the further course of the program routine. The camera of the second device is thereby activated. At step 4b of FIG. 2 (method step 3 in FIG. 1), the representation of the barcode on the display of the first device is recorded with the camera of the second device 2, generating a recording signal. The second device 2 transmits the recording signal or a second information that is dependent on the recording signal to the verification device 3 (step 4 in the FIG. 1). The verification device 3 generates from the recording signal, and/or the second information, a second verification information, and compares the first verification information and the second verification information with one another. The comparison of the first verification information with the second verification information compares whether the part of the first verification information, and of the second verification information, which contains information encoded in the barcode, or information read out from the barcode, match. Furthermore, it is checked in the comparison, whether the information about the time of the recording (which is stored in a part of the second verification information) that is also transmitted from the second device 2 to the verification 3, is inside a validity period, which is stored as part of the first verification information. It is also checked in the comparison whether the payment that is part of the first verification information has not already been activated and the first verification information has therefore already been deactivated. The verification device sends at step 5 of FIG. 1 an information to an account management system 6 when it is detected during the comparison that the information included in the barcode, and the information determined from the barcode match, that the recording was made at a time when the barcode was still active and has not already been redeemed with a previous recording of the barcode. Based on this information, a transaction signal (step 6 in FIG. 1) is generated in the account management system 6, with which the amount (12.99) selected by the first user in step 3a of FIG. 2 is debited from the account A of the user A and credited to the account B of the user B.

After successfully debiting and crediting the accounts, confirmation information is sent to the user A and the user B at step 5a and step 5b in FIG. 2, respectively. Thereafter, the user A and/or the user B can select whether he wishes to enter in the current program routine again at the step 2 of FIG. 2, or terminate the program routine.

The step illustrated in FIG. 1 as the second step may in an alternative embodiment to the aforedescribed embodiment also involve that the data processing device 4 of the first device 1 sends a signal, wherefrom the first device 1 can then produce a NFC signal. In this alternative embodiment, the step illustrated in FIG. 1 as the step 3 causes the first device 1 to transmit the NFC signal to the second device 2, and the second device 2 generates a recording signal based on the NFC signal.

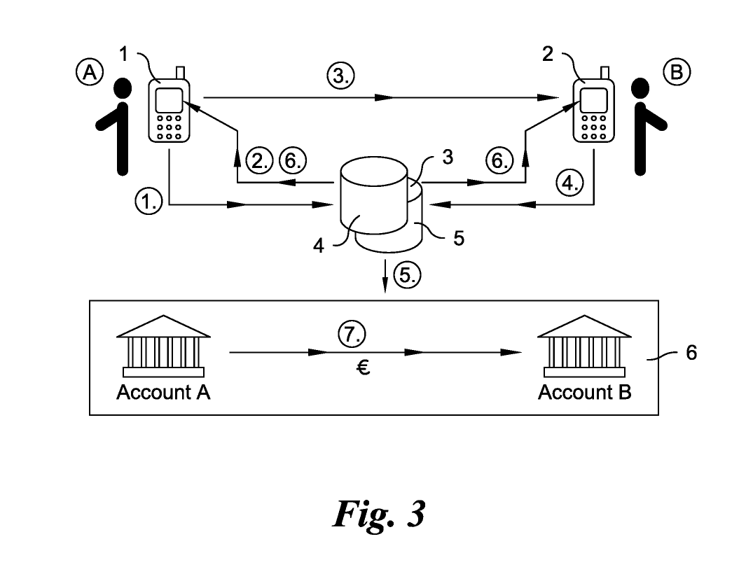

In the alternative embodiment shown in FIG. 3, a confirmation signal is sent to the first device 1 and to the second device 2 at the step 6, whereafter the step described in FIG. 1 as the step 6 and the aforedescribed step are executed. Moreover, the additional process steps (step 1 to 5) are executed in this process shown in FIG. 3, as previously shown and described in conjunction with FIGS. 1 and 2.

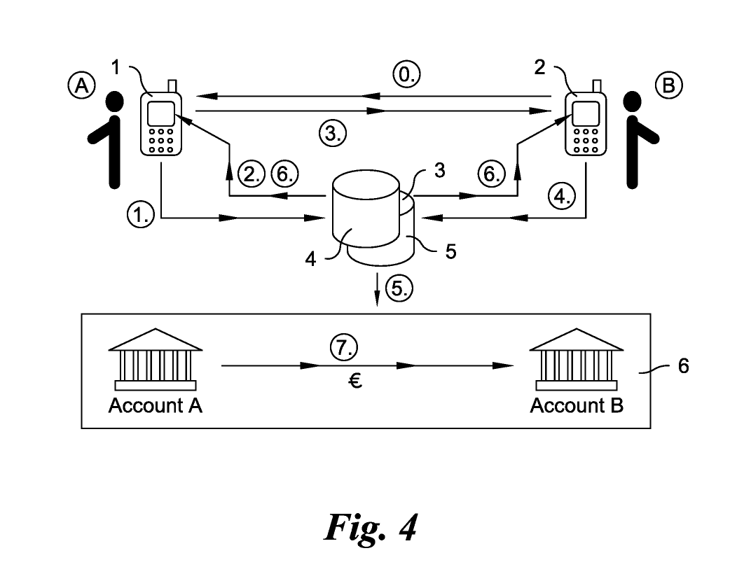

In the alternative embodiment shown in FIG. 4, a step 0 is illustrated in addition to the steps shown in FIG. 3, where a request NFC signal is transmitted. Thus the second device 2, for example, a cash register system may generate a request NFC signal which depends on an amount, for example, an amount to be paid for a product, which is transmitted from the second device 2 to the first device 1 using the Near Field Communication standard (step 0 in FIG. 4). The first user can generate a first information based on the request NFC signal received from the first device 1. This may be accomplished, for example, by causing the first user to perform an authentication step with the first device. As soon as the first information is generated, the additional steps of (1 to Step 7) are also executed with this method illustrated in FIG. 4, as was shown and described earlier in conjunction with FIG. 3.

FIGS. 1 to 4 are designed so that a user who wants to pay a claim (i.e., an amount is to be withdrawn from his account, (see step 6 (FIGS. 1, 2), and step 7 (FIGS. 3, 4)) is shown at the left-hand side, and the user whose claim is to be paid is shown on the right-hand side of each Figure. FIGS. 1 to 4 are furthermore designed so that the left user reproduces the at least two-dimensional representation on his first display device 1, or that the left user sends the NFC signal with his first device 1.

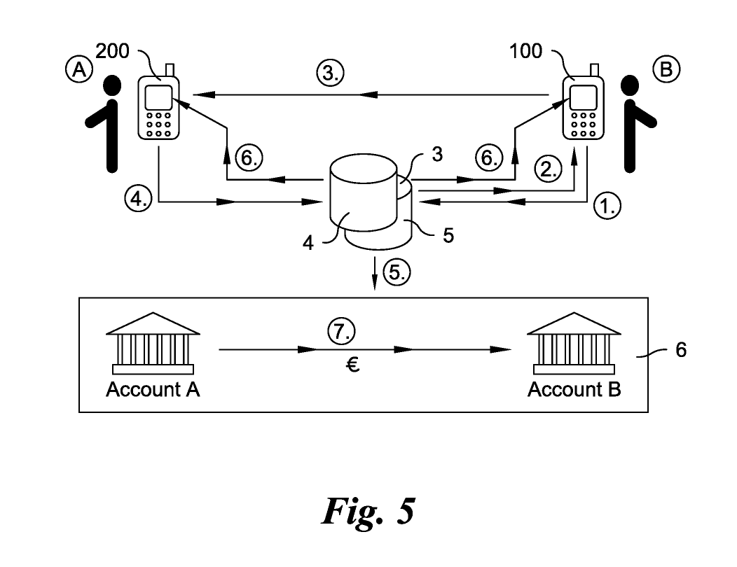

It will now be explained with reference to FIG. 5 that an embodiment of the invention may also be designed so that the user whose claim should be paid (also shown in FIG. 5 as the right user) reproduces the at least two-dimensional representation on the display to his first device 100, or that the right user sends the NFC-signal with his first device 100, and the user who will pay the claim (shown in FIG. 5 also as the left user) records with the camera of his second device 200 the representation displayed on the first device 100 of the right user illustrated, or receives with his second device 200 the NFC signal sent from the first device 100.

For illustrative purposes, the embodiment shown in FIG. 5 is described as if the first device 100 were part of a cash register system a merchant (the merchant is the user shown as the right user) and the second device 200 the mobile phone of a buyer (the buyer is the user shown as the left user). The merchant (user B, right user) starts a program routine in his cash register system (first device 100). After the program routine has started, the program routine may prompt the user B to select an amount. The user B enters via an (unillustrated) input device the requested amount. After this input, the first device 100 generates an information that depends on the amount selected by the user and, moreover, contains an identification feature of the first device 100. The first device 100 transmits the first information to the verification device 3 (step 1 in FIG. 5). The verification device 3 generates based on the first information a signal. The verification device 3 also generates a first verification information based on the first information. The signal is transmitted from the verification device 3 to the first device 100 (step 2 in FIG. 5). After receiving the signal, the first device 100 generates an NFC signal that is transmitted to the second device 200. The NFC signal is received by the second device 200 (step 3 in FIG. 5). After receiving the signal, the second device 200 generates a request on the display of the second device 200 and prompts the user A (the left user) to enter a PIN. The user A enters the PIN via an input device of the second device 200. The second device 200 generates a second information that depends on the NFC signal, the PIN entered by the user, and an identification feature of the second device 200. The second device 200 transmits the second information to the verification device 3 (step 4 in FIG. 5). The verification device 3 generates from the second information a second verification information, and compares the first verification information and the second verification information with one another. If the items of information to be verified within the framework of the comparison match, then the verification device generates confirmation signals which are transmitted to the first device 100 (to the user B, the right user) and to the second device 200 (to the user A, the left user) (Step 6 in FIG. 5). Based on the confirmation signal, the merchant (user B, right user) can print a receipt which he hands over to the customer (user A, left user). Additionally, the verification device transmits at step 5 of FIG. 5 an information to an account management system 6. Based on this information, a transaction signal is generated in the account management system 6 (step 7 in FIG. 1), with which the amount selected by the user B and confirmed by the user A by entering the PIN is debited from the account A of the user A and credited to the account B of the user B.

1. A method for generating a transaction signal using a first device and a second device, wherein at least one of the first device and the second device is configured to be carried by a user, the method comprising:
the user generating with a first device a first information which depends on an amount,
transmitting the first information with the first device to a verification device, generating with the verification device in response to the first information a signal which is configured to be converted by the first device into an at least two-dimensional representation adapted to be displayed on a display of the first device, generating with the verification device a first verification information based on the first information,
transmitting the signal from the verification device to the first device, converting the signal with the first device into the at least two-dimensional representation, and displaying the at least two-dimensional representation on the display of the first device,
recording the at least two-dimensional representation on the display of the first device with a camera of a second device and producing a recording signal, transmitting the recording signal, or a second information that depends from the recording signal, with the second device to the verification device or to an alternative verification device,
generating with the verification device or with the alternative verification device from the recording signal or from the second information a second verification information,
comparing the first verification information with the second verification information, and
generating the transaction signal when the comparison between the first verification information with the second verification information produces a predetermined result.

2. The method of claim 1, wherein at least one of the first device and the second device is a portable computer or a mobile phone.

3. The method of claim 2, wherein a mobile phone network is used for at least one of the following transmissions:
transmitting the first information from the first device to the verification device,
transmitting the signal from the verification device to the first device,
transmitting the recording signal from the second device to the verification device or to the alternative verification device, and
transmitting the second information from the second device to the verification device or to the alternative verification device.

4. The method of claim 1, further comprising converting the signal generated by the verification device signal with the first device into an at least two-dimensional representation of a barcode, and reproducing the at least two-dimensional representation of the barcode on the display of the first device.

5. The method of claim 1, further comprising starting a program routine on the first device, and the user entering—for generating the first information—only a user-selected amount without any additional information.

6. The method of claim 1, further comprising starting a program routine on the second device, and generating with the second device the recording signal or the second information to be transmitted, without inputting any additional information into the second device.

7. The method of claim 1, further comprising transmitting a confirmation information to at least one of the first device and the second device when the transaction signal is generated.

8. A method for generating a transaction signal using a first device and a second device, wherein at least one of the first device and the second device is configured to be carried by a user, comprising:
the user generating with a first device a first information which depends on an amount,
transmitting the first information with the first device to a verification device,
generating with the verification device in response to the first information a signal which is configured to be converted by the first device into an at least two-dimensional representation adapted to be displayed on a display of the first device,
generating with the verification device a first verification information based on the first information,
generating with the first device, based on the signal, an NFC-signal for transmission from the first device to a second device by using a Near-Field Communication standard, and transmitting the NFC-signal from the first device to the second device using the Near-Field Communication standard,
generating with the second device a recording signal based on the received NFC signal,
transmitting the recording signal, or a second information that depends from the recording signal, with the second device to the verification device or to an alternative verification device,
generating with the verification device or with the alternative verification device from the recording signal or from the second information a second verification information,
comparing the first verification information with the second verification information, and
generating the transaction signal when the comparison between the first verification information with the second verification information produces a predetermined result.

9. The method of claim 8, wherein at least one of the first device and the second device is a portable computer or a mobile phone.

10. The method of claim 8, wherein a mobile phone network is used for at least one of the following transmissions:
transmitting the first information from the first device to the verification device,
transmitting the signal from the verification device to the first device,
transmitting the recording signal from the second device to the verification device or to the alternative verification device, and
transmitting the second information from the second device to the verification device or to the alternative verification device.

11. The method of claim 8, further comprising starting a program routine on the first device, and the user entering—for generating the first information—only a user-selected amount without any additional information.

12. The method of claim 8, further comprising starting a program routine on the second device, and generating with the second device the recording signal or the second information to be transmitted, without inputting any additional information into the second device.

13. The method of claim 8, further comprising transmitting a confirmation information to at least one of the first device and the second device when the transaction signal is generated.
